(19) United States
(12) Patent Application Publication
(10) Pub. No.: US 2026/0180109 A1
(43) Pub. Date: Jun. 25, 2026

(54) BATTERY CELL COVER FOR ISOLATING A BATTERY CELL

(71) Applicant: Toyota Motor Engineering & Manufacturing North America, Inc., Plano, TX (US)

(72) Inventor: Natalie J. Spero, Erie, PA (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/999,508

(22) Filed: Dec. 23, 2024

(51) Int. Cl. H01M 50/271; H01M 50/291

(52) U.S. Cl. CPC H01M 50/271; H01M 50/291; H01M 2220/20

(57) ABSTRACT

Methods, systems, and devices for a nonconductive battery cell cover. The battery cell cover may include a left nonconductive rectangular plate having a top portion configured to cover a plurality of upper left battery cells and a bottom portion configured to cover a plurality of lower left battery cells. The nonconductive battery cell cover may further include a right nonconductive rectangular plate having a top portion configured to cover a plurality of upper right battery cells and a bottom portion configured to cover a plurality of lower right battery cells. The rectangular plates may be spaced apart to create first and second channels therebetween, the first channel or the second channel exposing (i.e., not covering) a battery cell to inspect. The nonconductive battery cell cover may further include a handle connected to the top surface of the left nonconductive rectangular plate or the right nonconductive rectangular plate.

### BACKGROUND

### 1. Field

The present disclosure relates to a system, method, and/or device, such as a battery cell cover, to inspection a vehicle battery cell and cover adjacent battery cells for isolation.

### 2. Description of the Related Art

A vehicle battery may include a number of battery cells. When stored for inspection, these vehicle battery cells may be stored in rows in a container or on a rack. These battery cells may need to be periodically inspected for damage or impurities. However, when inserting, handling, or removing the battery cells for inspection, there is a risk that the terminals of the battery cell may come into contact with each other, creating a safety risk. For example, when putting a battery cell back into a container, an arc can arise if the bottom of the cell comes into contact with the top terminals of the neighboring cells. The arc can lead to thermal instability or runaway in the cell and may create a weld between the cells due to the energy of the arc.

Currently, there is no technology being used to solve this issue. Rather, existing methods involve an individual performing the inspection to cover the top terminals with their fingers and conduct their work (e.g., battery inspection) and accordingly as to not make the cells come into contact with each other. However, using this existing method, the individual performing the inspection is at risk of making an error resulting in battery contact and thereby creating an electrical hazard.

Accordingly, it is desirable to provide systems, methods, and devices for covering and isolating adjacent or neighboring battery cell terminals from the battery cell being inspected.

### SUMMARY

In general, one aspect of the subject matter described in this disclosure may be embodied in a nonconductive battery cell cover for aligning and isolating a vehicle battery cell (e.g., a battery cell to be inspected) from adjacent battery cells in an inspection line to prevent a short or an electrical arc from the adjacent battery cells coming into contact with the vehicle battery cell. The battery cell cover may be made of a nonconductive material, which may be plastic, rubber, and/or a non-conductive composite material.

The nonconductive battery cell cover may include a left nonconductive rectangular plate having a top portion configured to cover a plurality of upper left battery cells and a bottom portion configured to cover a plurality of lower left battery cells, the top portion and the bottom portion defining a cutout therebetween. The nonconductive battery cell cover may further include a right nonconductive rectangular plate having a top portion configured to cover a plurality of upper right battery cells and a bottom portion configured to cover a plurality of lower right battery cells, the left nonconductive rectangular plate and the right nonconductive rectangular plate spaced apart from each other to create first and second channels therebetween, the first channel or the second channel exposing a battery cell to inspect, the battery cell being able to be pulled up through the first channel or the second channel for inspection as the adjacent cells are covered by the left nonconductive rectangular plate and the right nonconductive rectangular plate. The nonconductive battery cell cover may further include a handle connected to the left nonconductive rectangular plate or the right nonconductive rectangular plate on the top surface of the left nonconductive rectangular plate or the right nonconductive rectangular plate, respectively. The handle of the battery cell cover may be oriented on the cover perpendicular to the bridge or parallel to the bridge.

The nonconductive battery cell cover may further include a bridge that connects the left nonconductive rectangular plate to the right nonconductive rectangular plate such that the first channel is above the bridge and the second channel is below the bridge.

The battery cell cover may also include a flange extending downward from the bottom surface of left nonconductive rectangular plate and the right nonconductive rectangular plate, the flange configured to align or contact onto the cells to isolate the cells from contact. The flange may accurately align the left nonconductive rectangular plate and the right nonconductive rectangular plate.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure. In the drawings, like reference numerals designate like parts throughout the different views.

FIG. 1 is a schematic of an example vehicle with an example battery according to an aspect of the disclosure.

FIG. 2 is a top view of an example battery cell cover according to an aspect of the disclosure.

FIG. 3 is a bottom view of the example battery cell cover of FIG. 2 according to an aspect of the disclosure.

FIG. 4 is a top view of another example battery cell cover having a horizontally oriented handle according to an aspect of the disclosure.

FIG. 5 is a top view of an example battery cell cover having a single slot for battery cell removal and insertion according to an aspect of the disclosure.

FIG. 6 is an example view of the example battery cell cover of FIG. 2 being used to cover a row of battery cells or terminals according to an aspect of the disclosure.

FIG. 7 is an example view of the example battery cell cover of FIG. 2 being used to cover a row of battery cells or terminals as an individual is removing a battery cell or terminal according to an aspect of the disclosure.

FIG. 8 is an example view of the example battery cell cover of FIG. 2 being used to cover a row of battery cells or terminals with a removed battery cell or terminal according to an aspect of the disclosure.

FIG. 9 is an example view of the example battery cell cover of FIG. 2 as used to cover a row of battery cells or terminals according to an aspect of the disclosure.

### DETAILED DESCRIPTION

Disclosed herein are systems, methods, and/or devices for implementing a battery cell cover for covering adjacent vehicle battery cells of a particular vehicle battery cell as it is being removed or replaced in a line of battery cells. Particular embodiments of the subject matter described in this disclosure may be implemented to realize one or more of the following advantages. The battery cell cover may be a nonconductive cover that is placed on top of a container or a rack holding rows of vehicle battery cells. While a single battery cell is being removed or replaced from a row of battery cells, the battery cell cover may cover adjacent vehicle battery cells in the row while including a slot or a channel in between for removing the single battery cell. Isolating the single battery cell that is being removed or replaced from adjacent battery cells results in the safe removal and replacement of the single battery cell, thus preventing electrical arching due to contact with one or more adjacent battery cells.

The battery cell cover creates a physical non-conductive barrier between the target battery cell (e.g., the battery cell being removed) in a row of battery cells and adjacent battery cells to the battery cell's top, bottom, and/or sides. The battery cell cover can consequently cover the terminals on the adjacent battery cells as well. The battery cell cover may therefore block and prevent contact between the adjacent or neighboring battery cell terminals and the battery cell that is being removed or replaced from the container or the rack. For example, the battery cell may be removed or replaced as part of an inspection process. The battery cell cover can improve safety of the inspection process by preventing contact between battery cell terminals during this process. Otherwise, contact between battery cell terminals may create a dangerous electrical arc. In addition to protecting the battery cells and the individual handling the battery cells from electrical hazards, the battery cell cover also assists the individual removing or replacing the cell in keeping track of where they are in the inspection line by aligning the cover in place to identify the battery cell the individual is currently handling. The term “individual” can also refer to a robot that is used for the removal or replacement of the battery cell.

The battery cell cover may be shaped in such a way as to allow an individual removing or reinserting battery cells into the inspection containers or rack to be protected from neighboring battery cell terminals, while allowing for the individual to have enough space to remove and replace the current battery cell. The battery cell cover may include slots, channels, or openings for cell removal and insertion that may extend through the end of the battery cell cover to maximize the space for an individual's fingers to grasp the cell. For example, the battery cell cover may be shaped in an “H” configuration or formation. The battery cell cover may also include a handle that enables an individual to slide the cover over to subsequent battery cells in the inspection line.

In one aspect, the subject matter may be embodied in a nonconductive battery cell cover for aligning and isolating a vehicle battery cell from adjacent battery cells in an inspection line to prevent a short or an electrical arc from the adjacent battery cells coming into contact with the target vehicle battery cell. The battery cell cover may include a left nonconductive rectangular plate having a top portion configured to cover a plurality of upper left battery cells and a bottom portion configured to cover a plurality of lower left battery cells, the top portion and the bottom portion defining a cutout. The battery cell cover may also include a right nonconductive rectangular plate having a top portion configured to cover a plurality of upper right battery cells and a bottom portion configured to cover a plurality of lower right battery cells. The left nonconductive rectangular plate and the right nonconductive rectangular plate are spaced apart to create first and second channels therebetween, the first channel or the second channel exposing a battery cell to inspect. The battery cell is able to be pulled up through the channel for inspection as the adjacent cells are covered by the left nonconductive rectangular plate and the right nonconductive rectangular plate. The battery cell cover also may include a handle connected to the left nonconductive rectangular plate or the right nonconductive rectangular plate and located on the top surface of the left nonconductive rectangular plate or the right nonconductive rectangular plate, respectively. The battery cell cover may also include a bridge that connects the left nonconductive rectangular plate to the right nonconductive rectangular plate such that the first channel is above the bridge and the second channel is below the bridge.

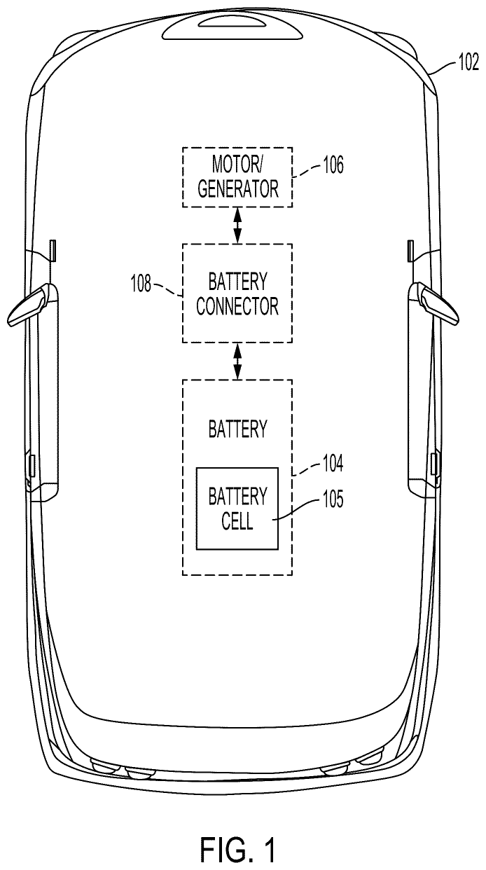

FIG. 1 illustrates an example vehicle 102 including an example battery 104. The vehicle 102 may be a conveyance capable of transporting a person, an object, or a permanently or temporarily affixed apparatus. The vehicle 102 may be a self-propelled wheeled conveyance, such as a car, a sports utility vehicle, a truck, a bus, a van or other motor, battery or fuel cell driven vehicle. For example, the vehicle 102 may be an EV, a HEV, a hydrogen fuel cell vehicle, a plug-in hybrid vehicle or any other type of vehicle that has a battery, a motor, an engine, and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The vehicle 102 may include a motor and/or generator 106 and/or the battery 104. The battery 104 may include one or more battery cells 105. The motor and/or generator 106 may be located within an engine bay of the vehicle 102. In examples, the motor and/or generator 106 may be located at and/or adjacent to at least one axel of the vehicle 102 such that the vehicle 102 includes a plurality of motors and/or generators 106. The motor and/or generator 106 may be an internal combustion engine (ICE). In this regard, the motor and/or generator 106 may combust an air and fuel mixture to provide power to the vehicle 102 and/or components of the vehicle 102. Accordingly, the motor and/or generator 106 can cause the vehicle 102 to accelerate, decelerate, or maintain a desired velocity. It should be understood that the motor and/or generator 106 may include combinations of an ICE and an electric motor, such as for HEV applications for example. In examples, the motor and/or generator 106 may be an electric motor. In this regard, the motor and/or generator 106 may be an electric motor and an electric generator that converts electrical energy into mechanical power, such as torque, and converts mechanical power into electrical energy. The motor and/or generator 106 may be electrically connected to the battery 104. The motor and/or generator 106 may convert energy from the battery 104 into mechanical power, and may provide energy back to the battery 104, for example, via regenerative braking.

The battery 104 may be retrofitted, coupled to, include or be included within the vehicle 102 (e.g., a complete HEV and/or EV) or separate from the vehicle 102 (e.g., during manufacturing when the battery 104 is being stored before installation into the vehicle 102). The battery 104 may be electrically connected to the motor and/or generator 106 and/or other components of the vehicle 102 through a battery connector 108. The battery 104 may store chemical energy for later conversion to electrical energy. The battery 104 may provide the electrical energy to and/or receive electrical energy from the motor and/or generator 106 and/or other components of the vehicle 102. The battery 104 may be a battery pack that includes one or more battery modules, a cooling system, and/or a battery management system (BMS). The one or more battery modules may each include one or more battery cells 105 and a frame to hold and protect the one or more cells 105. The one or more cells 105 may be cylindrical cells, prismatic cells, and/or pouch cells (in examples, other types of cells may be used). A chemistry of the one or more cells 105 may be lithium ion (Li-Ion), nickel manganese cobalt (NMC), nickel metal hydride (Ni-MH), lithium sulfur (Li-S), and/or lead-acid (in examples, other chemistries may be used).

The battery connector 108 may electrically connect the battery 104 to one or more components of the vehicle 102. The battery connector 108 may include a receiving connector and/or a plug connector. The receiving connector may connect (or mate) with the plug connector to establish an electrical connection between the battery 104 and the one or more components of the vehicle 102 and may disconnect from the plug connector to terminate the electrical connection.

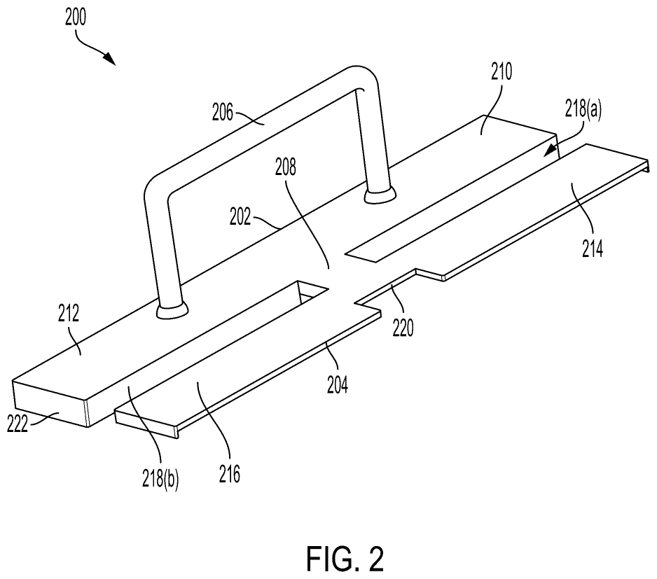

FIGS. 2-5 illustrate various aspects of an example battery cell cover 200 from various views. With combined reference to FIGS. 2-5, the battery cell cover 200 may include a left nonconductive rectangular plate 202, a right nonconductive rectangular plate 204, a handle 206, and a bridge 208. The left nonconductive rectangular plate 202 may include a top portion 210 configured to cover a plurality of upper left battery cells and a bottom portion 212 configured to cover a plurality of lower left battery cells.

The right nonconductive rectangular plate 204 may have a top portion 214 configured to cover a plurality of upper battery cells and a bottom portion 216 configured to cover a plurality of lower battery cells. The left nonconductive rectangular plate 202 and the right nonconductive rectangular plate 204 may be spaced apart to create a first channel 218(a) and a second channel 218(b) therebetween. The first channel 218(a) or the second channel 218(b) may expose a battery cell to inspect, where the battery cell may be pulled up through the channel for inspection as the adjacent cells are covered by the left nonconductive rectangular plate 202 and the right nonconductive rectangular plate 204. The top portions and the bottom portions of the left nonconductive rectangular plate 202 or the right nonconductive rectangular plate 204 may define a cutout 220. The cutout 220 may be used to allow the battery cell cover 200 to slide all the way to the side of the row of battery rows without being obstructed by a row arm at the end of the row.

The battery cell cover 200 may further include a flange 222 that may extend downward from the bottom surface of the left nonconductive rectangular plate 202 and/or the right nonconductive rectangular plate 204. The flange 222 may be configured to align, partially surround or contact onto the battery cells to isolate the battery cell from contact with adjacent battery cells. The flange 222 may therefore prevent the current battery cell being removed (i.e., the target battery cell) from coming into contact with adjacent or neighboring cells by creating a physical vertical barrier between the current battery cell and the adjacent or neighboring cells. The flange 222 may also be used to hold the battery cell cover 200 in place over a container. For example, the flange 222 may extend over the edge of the container to keep the battery cell cover 200 in place. In this way, the individual removing or inserting the battery cell into the container may do so with both hands rather than holding the battery cell cover 200 in place. The flange 222 can further prevent the walls from scratching the tops of the cells where the battery terminals are raised up from the top face of the cell.

The battery cell cover 200, including the left nonconductive rectangular plate 202, the right nonconductive rectangular plate 204, the handle 206, the bridge 208, and/or the flange 222, may be made of a type of non-convective material, such as plastic or rubber. For example, the battery cell cover 200 may be made from a polylactic acid (PLA) 3D printed plastic medium. The battery cell cover 200 may be a hands-free cover that can sit in place on a battery holding container without hindering the movement or abilities of the individual inspecting the battery cells. Therefore, the individual is able to use two hands to handle the battery cell as the flange 222 of the battery cell cover 200 may hold the cover 200 in place over the battery cell container. In addition, the battery cell cover 200 can prevent any potential physical contact between the battery cell being removed and the battery cell terminals in adjacent or neighboring battery cells, which can protect both the individual and the terminals.

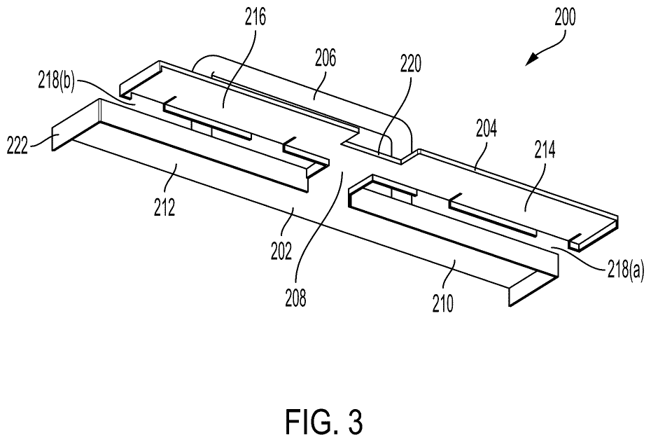

The battery cell cover 200 may be used to cover directly adjacent or neighboring battery cell terminals as a battery cell is inserted or removed through the channels 218(a) and/or 218(b). The battery cell cover 200 may be of a size and shape to adequately cover adjacent and/or neighboring battery cell terminals of a cell terminal currently being inspected. For example, the battery cell cover 200 may be shaped, such as in FIG. 2 and FIG. 3, to cover battery cells to the left and right of two cells above and below each other in two rows of battery cells that are under inspection and also cover the area between the two cells under inspection (e.g., via the bridge 208). The bridge 208 may be large enough to cover the space between the two cells. The left nonconductive rectangular plate 202 and the right nonconductive rectangular plate 204 may also be large enough to cover at least one adjacent battery cell to the present battery cell being removed or inserted on the left and/or right of the channels 218. As an example, where a battery cell terminal is 120 millimeters long, the left nonconductive rectangular plate 202 and the right nonconductive rectangular plate 204 may be 266 millimeters long.

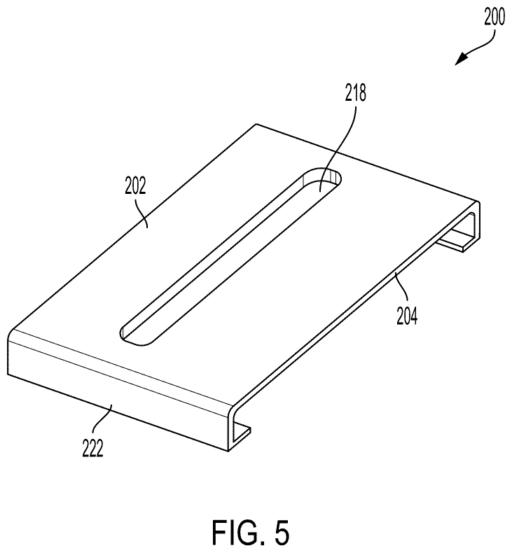

However, the above described shape of the battery cell cover 200 is not meant to be limiting or required. In other aspects, the battery cell cover 200 may be in the shape of a square, rectangle, or other configuration. For example, the battery cell cover 200 may be in the shape of a rectangle with a single channel 218 in the middle, such as that shown in FIG. 5. In other examples, the battery cell cover 200 may also be in the shape of a rectangular “8,” where the battery cell cover 200 is in a rectangle shape with two channels 218 one above the top, or “U” shape, where the battery cell cover 200 is a rectangle shape with a single channel that extends to the edge of the battery cell cover 200. Other shapes and sizes may also be possible.

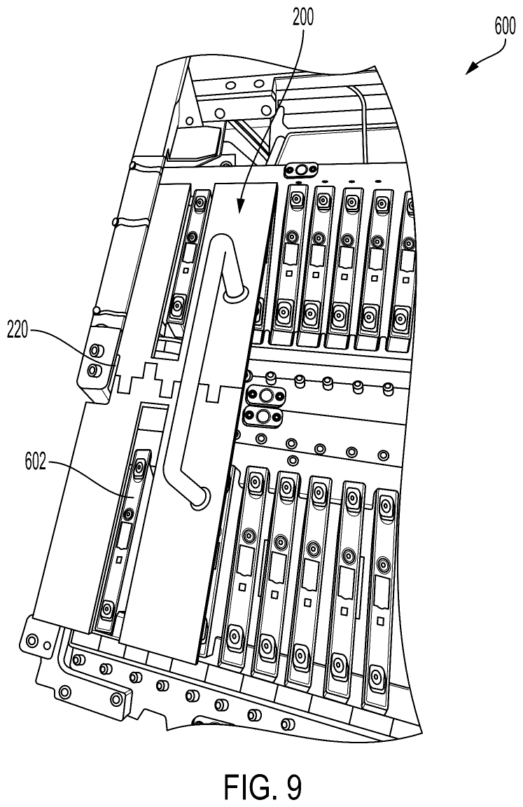

The channels 218(a)-(b) may be openings in the battery cell cover 200. The channels 218(a)-(b) may be configured in such a way to allow enough space between the left nonconductive rectangular plate 202 and the right nonconductive rectangular plate 204 so that an individual handling a battery cell can remove and reinsert the battery cell into the container. In examples, the individual may be wearing gloves or the robot may have non-conductive (e.g., plastic and/or rubber) fingers. Therefore, the channels 218(a)-(b) may be configured to allow enough space so that an individual wearing gloves can still safely and securely grasp the upper and lower sides of the battery cell to remove or reinsert it into the container. In examples, the channels 218(a)-(b) may extend through the end of the battery cell cover 200 in order to maximize the space of an individual handing the cell's fingers to grasp the cell. However, this is not meant to be limiting or required, as in other aspects, there may be alternative configurations for the channels, such as shown and described in FIG. 9 where the channel is fully enclosed.

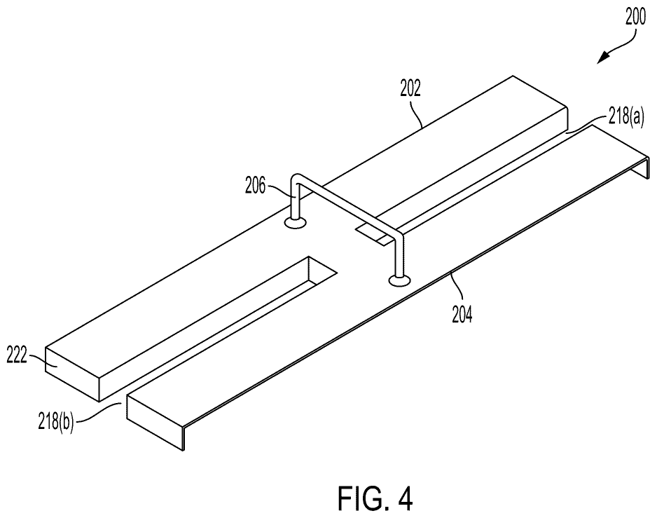

The handle 206 may be configured as a grabbing area for a user to grab onto to pull and/or to push the battery cell cover 200 across a row of battery cells in a container or a rack, for example. In examples, the handle 206 may be and/or include one or more grab handles. The handle 206 may also be used to place the battery cell cover 200 onto the row of battery cells. Optionally, the handle 206 may include one or more buttons (or other input devices) that are configured to latch or unlatch to the battery cell cover 200. In addition or alternatively, in examples, the one or more buttons on the handle 206 may be configured to lock or unlock the battery cell cover 200 when the battery cell cover 200 is placed on the container and is in use. The handle 206 may be placed on the top cover 202 of the battery cell cover 200 so that the handle 206 is out of the way of any battery cell removal or insertion movements by the individual handling the battery cells. The handle 206 may be of a size that can accommodate a broad range of individuals that may be handling the battery cells. In examples, the handle 206 may be attached to the left nonconductive rectangular plate 202 or the right nonconductive rectangular plate 204. The handle 206 may be attached in a horizontal fashion (e.g., parallel to the channels 218), as shown in FIG. 2, or a vertical fashion (e.g. perpendicular to the channels 218), as shown in FIG. 4.

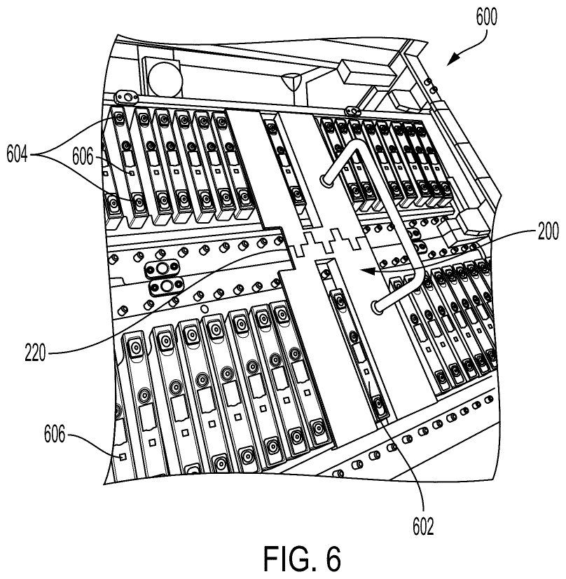

FIGS. 6-9 illustrate example views of the example battery cell cover 200 of FIG. 2 as used to cover battery cells 602 in a row 606. With combined reference to FIGS. 6-9, the battery cell cover 200 may be placed on a container 600. The container 600 may include one or more rows 606 that can store a number of battery cells 602. FIGS. 4-7 depict a container 600 with two rows 606 but other variations may also be possible. For example, in other embodiments, the container 600 may include one row, two rows or more than two rows. Each row 606 may include one or more battery cells 602. Each battery cell 602 may have at least one battery cell terminal 604. The battery cells 602 may be organized in the rows in a horizontal fashion. However, in other aspects, the battery cells 602 may be organized in a vertical fashion or other orientation within a container.

The battery cell cover 200 may be attached to the container 600 by a flange of the battery cell cover 200, such as the flange 222 shown in FIGS. 2-5. The battery cell cover 200 can be moved across the rows 606 using the handle (e.g., as an individual moves across the row 606 to inspect individual battery cell terminals 602). For example, the individual can grab the handle to push and/or pull the battery cell cover 200 across the row.

The battery cell cover 200 may include a rectangular cutout 220 on the right or left side of the battery cell cover 200 in order to allow the battery cell cover 200 to fit under an arm on the machine that holds the container 600 in the top-face inspection area. Otherwise, the battery cell cover 200 may not slide far enough to the side of the container 600 to allow for removal of the second cell from the end of the container 600.

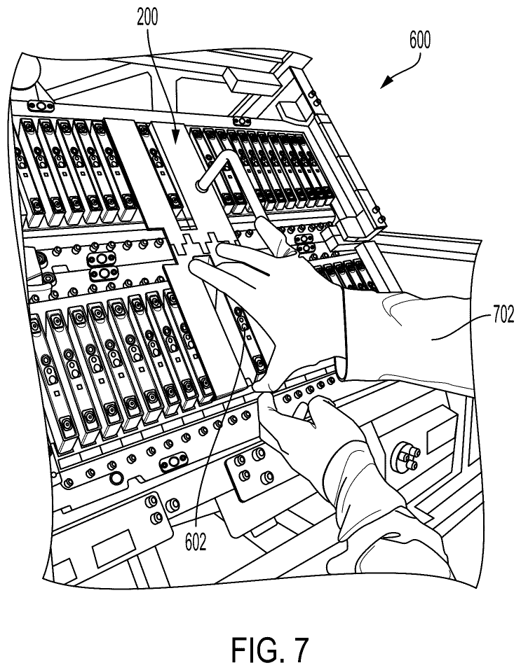

FIG. 7 depicts the battery cell cover 200 being utilized by an individual 702 (e.g., a human). As shown in FIG. 7, the individual 702 can use the battery cell cover 200 to align with a particular cell 602 and cover the cells adjacent to the particular cell 602 while the individual 702 is removing the cell 602 from the container 600. In this example, the individual 702 may be wearing gloves and nonetheless able to have sufficient space within the battery cell cover 200 slot in order to remove the cell 602 without the risk of the cells 602 making contact.

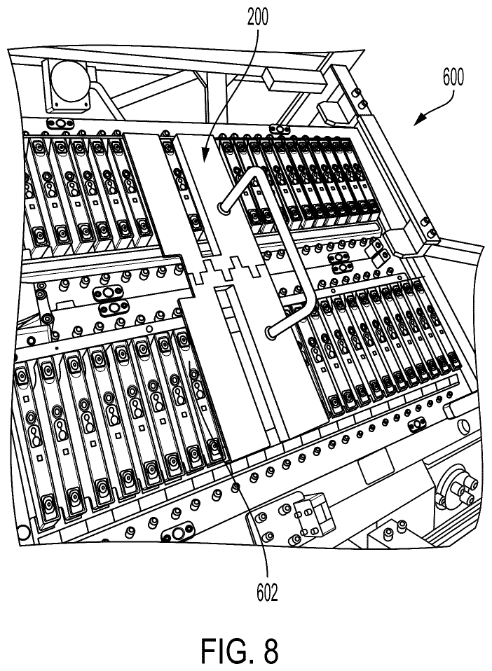

FIG. 8 depicts the battery cell cover 200 placed on the container 600 with a battery cell 602 removed between the channels of the battery cell cover 200. For example, FIG. 8 may depict a battery cell inspection line after a battery cell is removed (e.g., following the removal as shown in FIG. 7).

FIG. 9 depicts the battery cell cover 200 that is placed at the end of a row in the container 600. The cutout 220 allows the battery cell cover 200 to be pushed all the way to the end of the row without the arm at the end of the row restricting its use. At the end of the row, the battery cell cover 200 enables access to the last battery cell terminals 602 in the row by allowing the device to slide around the arm due to the cutout 220.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A nonconductive battery cell cover for aligning and isolating a vehicle battery cell from adjacent battery cells in an inspection line to prevent a short or an electrical arc from the adjacent battery cells coming into contact, comprising:
a left nonconductive rectangular plate having a top portion configured to cover a plurality of upper left battery cells and a bottom portion configured to cover a plurality of lower left battery cells, the top portion and the bottom portion defining a cutout therebetween;
a right nonconductive rectangular plate having a top portion configured to cover a plurality of upper right battery cells and a bottom portion configured to cover a plurality of lower right battery cells, the left nonconductive rectangular plate and the right nonconductive rectangular plate spaced apart from each other to create first and second channels therebetween, the first channel or the second channel exposing a battery cell to inspect, the battery cell being able to be pulled up through the channel for inspection as the adjacent cells are covered by the left nonconductive rectangular plate and the right nonconductive rectangular plate;
a handle connected to the left nonconductive rectangular plate or the right nonconductive rectangular plate on the top surface of the left nonconductive rectangular plate or the right nonconductive rectangular plate, respectively; and
a bridge that connects the left nonconductive rectangular plate to the right nonconductive rectangular plate such that the first channel is above the bridge and the second channel is below the bridge.

2. The nonconductive battery cell cover of claim 1, further comprising a flange extending downward from the bottom surface of left nonconductive rectangular plate and the right nonconductive rectangular plate, the flange configured to align or contact onto the cells to isolate the cells from contact.

3. The nonconductive battery cell cover of claim 1, wherein the flange accurately aligns the left nonconductive rectangular plate and the right nonconductive rectangular plate.

4. The nonconductive battery cell cover of claim 1, wherein the battery cell cover is made of a nonconductive material.

5. The nonconductive battery cell cover of claim 4, wherein the nonconductive material comprises one or more of: plastic or rubber.

6. The nonconductive battery cell cover of claim 1, wherein the handle is oriented on the cover perpendicular to the bridge.

7. The nonconductive battery cell cover of claim 1, wherein the handle is oriented on the cover parallel to the bridge.

8. A battery cell cover for aligning and isolating a target battery cell from adjacent battery cells located in a container or on a rack to prevent a short or an electrical arc from the adjacent battery cells coming into contact with the target battery cell, comprising:
a left nonconductive rectangular plate having a top portion configured to cover a plurality of upper left battery cells and a bottom portion configured to cover a plurality of lower left battery cells, the top portion and the bottom portion defining a cutout therebetween;
a right nonconductive rectangular plate having a top portion configured to cover a plurality of upper right battery cells and a bottom portion configured to cover a plurality of lower right battery cells, the left nonconductive rectangular plate and the right nonconductive rectangular plate spaced apart from each other to create first and second channels therebetween, the first channel or the second channel exposing the target battery cell to inspect, the target battery cell being able to be pulled up through the first channel or the second channel for inspection as the adjacent battery cells are covered by the left nonconductive rectangular plate and the right nonconductive rectangular plate; and
a bridge that connects the left nonconductive rectangular plate to the right nonconductive rectangular plate such that the first channel is above the bridge and the second channel is below the bridge.

9. The battery cell cover of claim 8, further comprising a handle connected to the left nonconductive rectangular plate or the right nonconductive rectangular plate on the top surface of the left nonconductive rectangular plate or the right nonconductive rectangular plate, respectively.

10. The battery cell cover of claim 9, wherein the handle is oriented perpendicular to the bridge.

11. The battery cell cover of claim 9, wherein the handle is oriented parallel to the bridge.

12. The battery cell cover of claim 9, wherein the handle includes one or more buttons configured to latch or unlatch the battery cell cover.

13. The battery cell cover of claim 9, wherein the handle includes one or more buttons configured to lock or unlock the battery cell cover when the battery cell cover is placed on a container or is in use.

14. The battery cell cover of claim 9, wherein the handle enables an individual or a robot to slide the left nonconductive rectangular plate, the right nonconductive rectangular plate, and the bridge over to subsequent battery cells in an inspection line.

15. The battery cell cover of claim 9, wherein the left nonconductive rectangular plate and the right nonconductive rectangular plate prevent any potential physical contact between the target battery cell being removed and battery cell terminals in the adjacent battery cells, which can protect both the individual and the battery cell terminals.

16. The battery cell cover of claim 8, further comprising a flange extending downward from a bottom surface of the left nonconductive rectangular plate and the right nonconductive rectangular plate, the flange configured to align or contact onto the adjacent battery cells to isolate the adjacent battery cells from contact with the target battery cell.

17. The battery cell cover of claim 16, wherein the flange accurately aligns the left nonconductive rectangular plate and the right nonconductive rectangular plate.

18. The battery cell cover of claim 8, wherein the battery cell cover is made of a nonconductive material.

19. The battery cell cover of claim 18, wherein the nonconductive material comprises one or more of plastic or rubber.

20. The battery cell cover of claim 8, wherein the left nonconductive rectangular plate, the right nonconductive rectangular plate, and the bridge are formed in the shape of a “H”.
